(19) United States
(12) Patent Application Publication
(10) Pub. No.: US 2013/0092291 A1
(43) Pub. Date: Apr. 18, 2013

(54) FILLING ELEMENT FOR A FILLING APPARATUS TO FILL CONTAINERS, GAS RETURN PIPE FOR A FILLING ELEMENT, AND LIQUID-DEFLECTING SHIELD FOR A GAS RETURN PIPE

(71) Applicant: KRONES AG, Neutraubling (DE)

(72) Inventor: Rudolf Fiegler, Neutraubling (DE)

(73) Assignee: KRONES AG, Neutraubling (DE)

(21) Appl. No.: 13/654,345

(22) Filed: Oct. 17, 2012

(30) Foreign Application Priority Data
Oct. 17, 2011 (DE) 10 2011 054 546.8

(51) Int. Cl. B67C 3/26; F17D 1/00

(52) U.S. Cl. 141/309; 137/377

(57) ABSTRACT

The present invention pertains to a filling element (1) for a filling apparatus (10) for filling containers (2), preferably for filling beverage containers, wherein the filling element (1) comprises at least one gas return pipe (32) comprising a liquid-deflecting shield (5), wherein said gas return pipe (32) can be inserted into the container (2) for filling, whereby the liquid-deflecting shield (5) comprises a metal-detectable plastic, (FIG. 1)

### CROSS-REFERENCE TO RELATED APPLICATION

The subject application claims priority to and the benefit of German Patent Application Number 10 2011 054 546.8, filed on Oct. 17, 2011 the entire disclosure of which is incorporated herein by reference.

### TECHNICAL FIELD

The present invention relates to a filling element for a filling apparatus for filling containers, in particular beverage containers, a gas return pipe for a filling element, and a liquid-deflecting shield for a gas return pipe.

### PRIOR ART

In the field of filling containers, in particular in the field of filling beverages, various processes are known for placing the liquid into the corresponding containers. Most of these methods have in common that a filling element is placed in contact with the respective container and the respective filling liquid is filled into the container via the filling element. Herein it is known, for example, to bring a filling element substantially sealed by means of a gasket into contact with the filling opening of a container, such as the filling opening of a glass bottle, and then to introduce the filling liquid into the container through a filling tube located in the center of the gasket. The gas that must be displaced from the container is led out of the container through a gas return pipe typically arranged concentrically to the filling opening.

In order to steady the filling process, a liquid-deflecting shield is typically arranged on the outer surface of the gas return pipe, which is designed so that the filling liquid flowing along the gas return pipe is deflected in the direction of the inner wall of the beverage container. The filling liquid which flows through the filling opening or along the filling nozzle which projects into the container and which passes through the gasket sealing the filling opening of the container is accordingly deflected laterally.

Such a filling element with a liquid-deflecting shield is shown in a specific embodiment, for example, in DE 200 09 507 U1.

The purpose of a liquid-deflecting shield is also shown in DE 1 149 262 A, wherein the liquid-deflecting shield is arranged on the gas return pipe and is designed so that the filling material flowing along the gas return pipe is washed onto the inner wall of the container to be filled.

During operation of a filling apparatus that uses such a filling element to fill a corresponding container, the liquid-deflecting shield and/or the gasket to seal the filling opening of the container may become damaged, for example if a container is destroyed during the filling process. This may, for example, already be the case, if the container is pretensioned at the beginning of the filling process, and is subjected accordingly to internal pressure. Liquid-deflecting shields may be damaged when the corresponding container explodes, for example by flying shards of glass. This damage may cause the liquid-deflecting shield to detach from the respective component, in particular from the filling nozzle and/or gas return pipe, or shards or particles of material from the liquid-deflecting shield may be passed into a container to be filled or into one that is already filled. This intrusion of foreign bodies may occur either immediately as the respective container breaks, or the damage to the liquid-deflecting shield may also be such that the associated components fall away during the next filling process, or even later, and are then for example washed away by the incoming flow of filling liquid, whereby portions of the liquid-deflecting shield enter into a completely filled container. The corresponding container is thus contaminated.

To prevent such contaminated containers from being brought to market, the containers are typically subjected to a so-called full bottle inspection after sealing, in which the bottle is subjected to various inspection processes. The container is for instance irradiated with light, to optically reveal suspended materials that do not belong in the respective fluid, or foreign bodies in the container. In addition, containers are typically passed through a metal detector, so that metal parts located in the container can be detected.

The liquid-deflecting shield is typically composed of an elastic material such as rubber or plastic. A liquid-deflecting shield or component thereof that is flushed into a filled container may correspondingly be detected optically in a full bottle inspection, if the particle size and the filling liquid permit.

### DISCLOSURE OF THE INVENTION

Starting with this known prior art, one object of the present invention is to specify a filling apparatus, a gas return pipe, and a liquid-deflecting shield, by means of which the reliability of the filling process is further increased.

This object is achieved by a filling element with the features of claim 1. Advantageous embodiments will be given in the dependent claims.

The filling element for a filling apparatus for filling containers, preferably to fill beverage containers, comprises accordingly at least one gas return pipe comprising a liquid-deflecting shield, which is insertable into the container to be filled. According to the invention, the liquid-deflecting shield comprises a metal-detectable plastic.

In that the liquid-deflecting shield comprises a metal-detectable plastic, when the liquid-deflecting shield is destroyed, and particles or components of the liquid-deflecting shield are subsequently introduced into a container, it can be achieved that the corresponding foreign bodies may be detected not only by means of an optical detection process, but also by means of a metal detector. Herein the accuracy of the detection of such undesirable components in a completely filled container is significantly increased. In particular, for very small components, which an optical process can differentiate from impurities in the filled liquid and/or gas bubbles in the container wall only with difficulty, metal detection can provide here an addition enhancement in safety.

In addition, full bottle inspectors are relatively elaborate. With the above-mentioned composition of a liquid-deflecting shield or seal in such a manner that they comprise a metal-detectable plastic, it will also be possible to dispense with elaborate optical inspection processes and to use significantly less costly metal detectors to detect any possible detached seals or liquid-deflecting screens. In some cases, optical detection may be dispensed with entirely.

For carbonated beverages, it is moreover difficult to identify small suspended particles that are in the same size range as the size of gas bubbles by means of an optical detection process. For such liquids to be filled, the proposed filling element offers a reliable method to detect contamination of a filled bottle by components of the filling shield.

The liquid-deflecting shield is preferably composed entirely of the metal-detectable plastic, in order to permit reliable detection of even the smallest fragmentary parts coming from the liquid-deflecting shield.

For metal-detectable plastics, the materials used here are preferably plastics based on ultra-high-molecular-weight polyethylenes (UHMWPE), plastics based on POM, and plastics based on PA6. However, other metal-detectable plastics and in particular metal-detectable thermoplastics may also be considered.

In a preferred embodiment, the liquid-deflecting shield comprises a form that is substantially conical, preferably shaped as a conical frustum, and exhibits a conical outer surface to repel the filling liquid, and which in addition provides a hole to receive the gas return pipe in the center of the body. In a particularly preferred further embodiment, the conical outer surface is concave, preferably with a radius that exceeds the largest diameter of the body of the liquid-deflecting shield.

The filling element may in addition comprise a centering cone to center the container's filling opening during filling, wherein at least one filling tube extends through the centering cone to fill the container, and whereby the centering cone comprises a metal-detectable plastic. In order to be able to detect even the smallest fragments and particles of the centering cone in a filled or to-be-filled container, the centering cone is preferably composed entirely of metal-detectable plastic.

Depending on the form of the filling opening of the container to be filled, the centering cone is preferably substantially of conical or conical frustum shape, and is preferably provided to seal the container's filling opening, to exert a sealing function in addition to its a centering function for the corresponding filling opening of the container.

The object described above is achieved in addition by a gas return pipe for use with the filling element described above with the features of claim 9. Advantageous embodiments will be given in the dependent claims.

The gas return pipe for the filling element accordingly comprises a liquid-deflecting shield that is accommodated within a groove in the gas return pipe. According to the invention, the liquid-deflecting shield comprises a metal-detectable plastic.

In this manner it can be ensured that parts or particles from a liquid-deflecting shield damaged or destroyed during filling that enter into a container to be filled or one that is already filled may be detected with a simple metal detector. For the reasons described above, the liquid-deflecting shield preferably is composed entirely of the metal-detectable plastic.

The liquid-deflecting shield preferably comprises a body that is substantially conical, preferably a conical frustum shape, and has a conical outer surface to deflect the filling liquid, and which in addition provides a hole to receive the gas return pipe in the center of the body. The conical outer surface is preferably concave, preferably with a radius that exceeds the largest diameter of the body of the liquid-control shield.

The object described above is achieved in addition by a liquid-deflecting shield with the characteristics of claim 14.

### BRIEF DESCRIPTION OF THE FIGURES

Preferred further embodiments and aspects of the present invention will be exemplified in detail by way of the following description of the figures. Herein is shown:

FIG. 1: a schematic of filling with a filling element to fill containers;

FIG. 2: a schematic of a liquid-deflecting shield in a sectional representation;

FIG. 3: a liquid-deflecting shield in a schematic perspective representation;

FIG. 4: a gas return pipe to be inserted into a container in a schematic sectional representation; and

FIG. 5: a schematic representation of a filling system.

### DETAILED DESCRIPTION OF PREFERRED SAMPLE EMBODIMENTS

Preferred embodiments will be described in the following on the basis of the figures. Here identical, similar, or equivalent elements are designated by identical reference numbers, and repeated descriptions of these elements are omitted in part in order to avoid redundancies in the description.

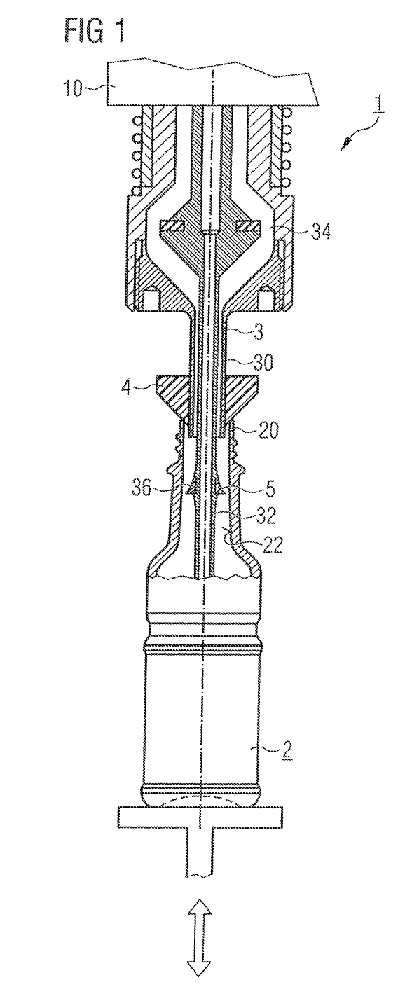

FIG. 1 shows a filling element 1 for a filling apparatus for filling containers 2, wherein the container 2 shown here is a beverage bottle with an upwards-directed filling opening 20, which is to be filled with a beverage as the filling

The filling element 1 comprises a filling nozzle 3, which serves to fill the container 2 with the filling liquid. The filling nozzle 3 comprises a filling tube 30 and a gas return pipe 32 arranged concentrically to the filling tube. The filling liquid which is to be filled into the container 2 flows within the space provided between the filling tube 30 and the gas return tube 32 into the container 2. Control of the respective flow of the filling liquid occurs by means of a filling valve 34, which permits the liquid to flow at the start of the filling operation and stops the liquid flow again at the end of the filling operation.

The gas return pipe 32 serves in addition to prevent excessive gas pressure in the container 2 during filling, and to prevent an excessive pressure in the container 2. Accordingly, gas may vent from the interior of the container via the gas return pipe 32. The gas return pipe 32 may also be used in a specific embodiment of the filling valve 34 to control the dosing time point of the filling valve 34.

The filling element 1 is typically a component of a filling apparatus 10, which is indicated only schematically in FIG. 1. The filling element 1 here may preferably be used in a carousel filler, which the filling apparatus 10 thus represents.

A centering cone 4 is provided around the filling tube 30, whereby the filling opening 20 of the container 2 is centered with respect to the filling tube 30. The centering cone 4 is designed as a conical frustum in the embodiment shown, in order to achieve a centering of the container's filling opening 20 around the filling tube 30.

The filling tube 30 extends through the centering cone 4 and protrudes slightly into the filling opening 20 of the container 2.

Beyond the primary centering functionality, the centering cone 4 may also be designed to substantially seal the container's filling opening 20. In this manner, a gas and liquid exchange between the interior of the container 2 and the environment may be avoided, which may be of importance for reasons of hygiene and/or when filling with a carbonated filling liquid. During some filling processes the containers 2 are also pretensioned, thus set under pressure, in order to prepare the container 2 for filling as well as simultaneously testing and ensuring the container's integrity.

A liquid-deflecting shield 5 is provided on the gas return pipe 32, which is held in a groove 36 of the gas return pipe 32. The liquid-deflecting shield 5 serves in addition to deflect the filling liquid entering from the filling tube 30 and flowing along the exterior of the gas return tube 32 and toward the inner wall 22 of the container 2. The process of filling the container 2 is thereby steadied, since the filling liquid flows downward along the inner wall 22 of the container 2 or slips upon it. The liquid does not simply fall from the filling opening 20 of the container 2 into the volume of the container 2, but rather runs along the inner wall 22 of the container 2. In particular, for foaming filling liquids, in this manner an improved filling behavior, and thus a more accurate filling is produced, due to the reduced foam formation.

The liquid-deflecting shield 5 comprises a metal-detectable plastic. The centering cone 4 may also comprise a metal-detectable plastic. The liquid-deflecting shield 5 and/or centering cone 4 are preferably formed entirely of the metal-detectable plastic.

A metal-detectable plastic is a plastic that can be detected by means of a known metal detector. Depending on the sensitivity of the metal detector, even small particles of the metal-detectable plastic may be detected. The metal-detectable plastic is preferably formulated so that even small particles in the scale of 3 mm×3 mm×3 mm may be detected by the metal detector. The metal-detectable plastics preferably have a food regulatory certification, for example, in accordance with EU Directive 2002/72/EC.

The metal-detectable plastic may be a plastic based on ultra-high-molecular-weight polyethylenes (UHMWPE), a plastic based on POM, and/or a plastic based on PA6. Other metal-detectable thermoplastics and other metal-detectable plastics may also be used.

The use of metal-detectable plastic for the liquid-deflecting shield 5 permits that in the event that the liquid-deflecting shield 5 is damaged or destroyed, and/or when small particles are dislodged, components or particles of the liquid-deflecting shield 5 that are passed into a bottle to be filled or one that is already filled may be detected by means of a metal detector. Such components or particles of a damaged or destroyed liquid-deflecting shield 5 may also detected by means of optical detection methods, for example by a full bottle inspection. These methods are technically elaborate and correspondingly expensive. In addition, it is difficult to detect particulate matter in filling liquids containing carbon dioxide when using optical methods. Especially smaller suspended particles and in particular suspended matter that is in size or volume range of the average bubble size of the carbonation in the filling liquid cannot be detected reliably. In contrast, the corresponding particles, fragments, or components can be detected reliably by means of a metal detector, and independently of the composition of the filling liquid.

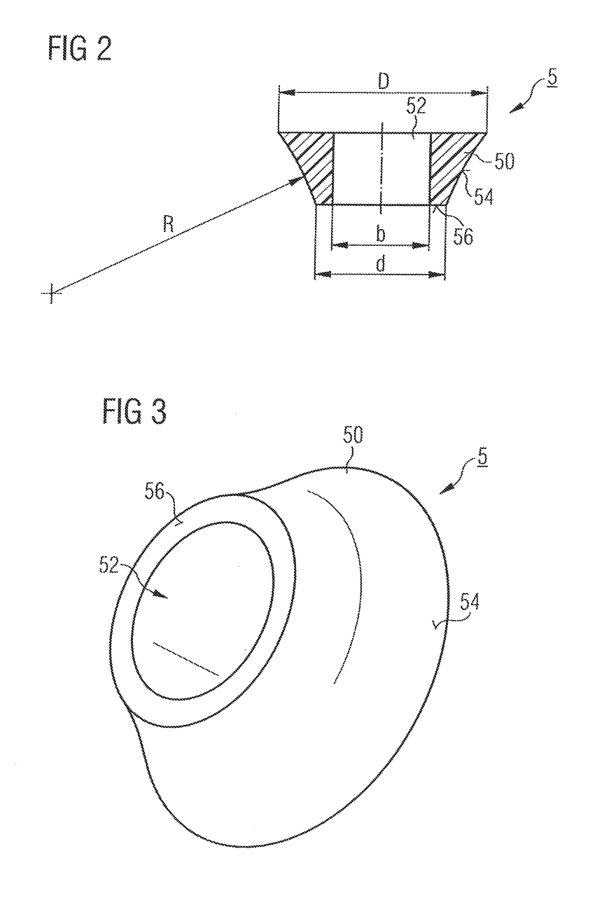

FIG. 2 shows a schematic of a liquid-deflecting shield 5. The liquid-deflecting shield 5 comprises a body 50 that is substantially formed as a conical frustum. A hole 52 is provided in the center of the body 50 through which for example the gas return pipe 32 shown in FIG. 1 will be passed. The conical outer surface 54 of the liquid-deflecting shield 5 that serves to deflect the filling liquid is preferably concave, whereby the radius R of the concave form is preferably significantly larger than the diameter D of the liquid-deflecting shield 5. In this manner, a gentle transition of the filling fluid onto the respective inner wall of the container to be filled can be achieved.

The smaller diameter “d” of the body 50 formed substantially as a conical frustum is preferably dimensioned in comparison to the diameter of the hole 52 (which is designated as “b”) in such a manner that the thickness of the annular conical frustum surface 56 can be accommodated entirely in the groove 36 of the gas return pipe. In this way, a substantially smooth transition from the circumference of the gas return pipe 32 to the conical outer surface 54 of the liquid-deflecting shield 5 can be achieved in the vicinity of the groove 36. In other words, (d−b)/2 corresponds approximately to the groove depth of the groove 36 of the gas return pipe 32.

The liquid-deflecting shield 5 is preferably manufactured entirely of the metal-detectable plastic, so that a reliable detection of fragments is possible with a metal detector even in case of individual shards flaking off.

FIG. 3 shows the liquid-deflecting shield 5 yet again in a schematic perspective representation. The body 50 with the hole 52 is clearly recognizable, as well as the conical outer surface 54 exhibiting a concave form. Equally recognizable is the conical frustum surface 56, whose thickness substantially corresponds to the groove depth of the groove 36 of the gas return pipe 32.

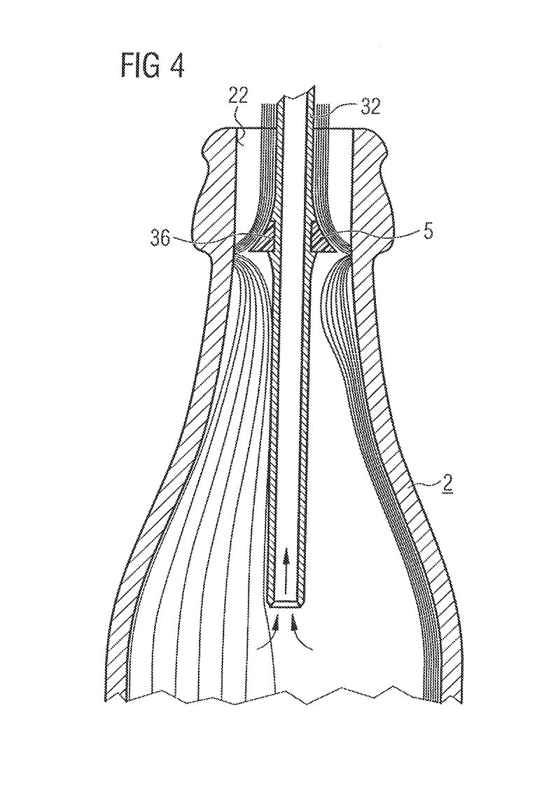

FIG. 4 shows a schematic of a gas return pipe 32 that is inserted into a container 2. The filling liquid flows along the return gas pipe 32 until it encounters a liquid-deflecting shield 5, also shown schematically. The liquid-deflecting shield 5 thus directs the filling liquid flowing along the gas return pipe 32 onto the inner wall 22 of the container 2, so that the filling liquid glides substantially down the inner wall 22 of the container 2. The filling process can be significantly steadied in this manner.

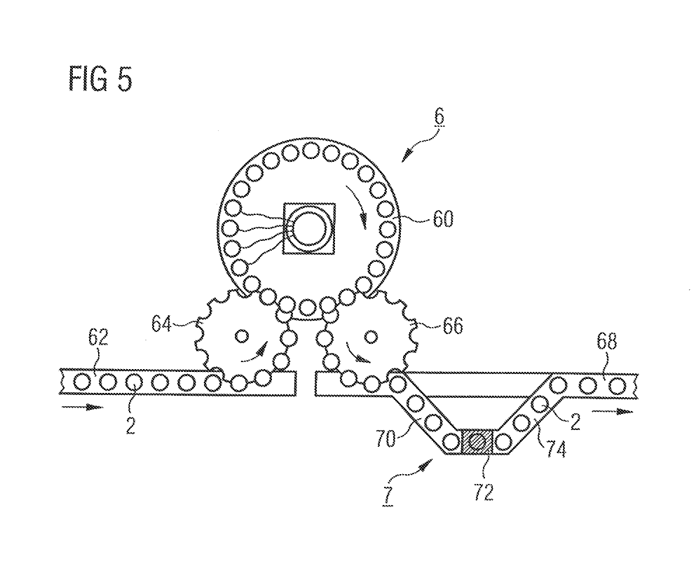

FIG. 5 shows a schematic of the design of a filling station in the form of a carousel filler 6. The carousel filler 6 comprises a filling carousel 60, which comprises a number of filling elements 1. The individual containers 2 are filled with the filling liquid in the filling carousel 60. Each respective container 2 is fed to a infeed starwheel 64 via a container infeed 62 comprising a conveyor belt, whereby the container 2 is passed to the filling carousel 60. A discharge starwheel 66 is provided that transfers the containers 2 to a container outlet 68 comprising a conveyor belt as well. A metal detection station 7 is provided at the container outlet 68, which exhibits an net 70, a metal detector 72, as well as an outlet 74. The arrangement of the metal detection station 7 immediately at the container outlet 68 following the filling carousel 60 allows direct detection of metal-detectable foreign bodies in the containers 2 that were filled in the filling carousel 60. Depending on the design of the container infeed 62, it can be ensured that when a foreign body is detected it is actually a foreign body inserted within the filling carousel 60.

In a preferred variant, an additional metal detector not shown in FIG. 5 is provided before the container infeed 62, which serves to measure a characteristic parameter for metal detection. This parameter is then recorded for each container 2 and is compared with the characteristic parameter measured by the metal detector 72 located at the container outlet. When a deviation exceeding a predetermined value occurs, the corresponding container 2 will be excluded as defective. In other words, changes in the characteristic parameter for metal detection in the container 2 will be monitored during the filling process, in order to be able to thereby derive a possible contamination of a container 2 with components of the filling element 1. In this manner it may also be verified that potential metallic foreign bodies detected in the metal detection station 7 at the container outlet 68 originate from the filling carousel 60. Based on this knowledge, the respective filling element or the filling carousel 60 may accordingly be repaired immediately, and the filling performance of the apparatus is correspondingly driven to a substantially constant high level.

In an additional preferable variant, the metal detector 72 is arranged spatially prior to the transfer of the respective container 2 back to the container outlet 68. This is particularly advantageous for a filling apparatus 10 that seizes the container 2 by the neck of the container (“neck handling”), in order to achieve a space-saving arrangement for the metal detection station 7.

In as much as they are employable, all of the individual features that are illustrated in the various embodiments may be combined with each other and/or may be exchanged without departing from the scope of the invention.

1. A filling element (1) for a filling apparatus (10) for filling containers (2), preferably for filling beverage containers, wherein the filling element (1) comprises at least one gas return pipe (32) comprising a liquid-deflecting shield (5), wherein said gas return pipe (32) can be inserted into the container (2) for filling, characterized in that the liquid-deflecting shield (5) comprises a metal-detectable plastic.

2. The filling element (1) in accordance with claim 1, characterized in that the liquid-deflecting shield (5) is composed entirely of the metal-detectable plastic.

3. The filling element (1) in accordance with claim 1, characterized in that the liquid-deflecting shield (5) exhibits a body (50) that is substantially of conical form. preferably a conical frustum shape, and comprises a conical outer surface (54) to deflect the filling liquid, and which in addition comprises a hole (52) to receive the gas return pipe (32) in the center of the body (50).

4. The filling element (1) in accordance with claim 3, characterized in that the conical outer surface (54) is concave, preferably with a radius (R) that is larger than the maximum diameter (D) of the body (50) of the liquid-deflecting shield (5).

5. The filling element (1) in accordance with claim 1, characterized in that at least one centering cone (4) to center the filling opening (20) of the container (2) during filling is provided, wherein at least one filling pipe (30) for filling the container (2) extends through the centering cone, wherein the centering cone (4) comprises a metal-detectable plastic.

6. The filling element (1) in accordance with claim 5, characterized in that the centering cone (4) is substantially conical, preferably a conical frustum shape, and is preferably intended to seal the filling opening (20) of the container (2).

7. The filling element in accordance with claim 5, characterized in that the centering cone (4) is composed entirely of the metal-detectable plastic.

8. The filling element (1) in accordance with claim 1, characterized in that the metal-detectable plastic is a thermoplastic, preferably a thermoplastic on the basis of ultra-high-molecular-weight polyethylenes (UHMWPE), on the basis of POM, and/or on the basis of PA6.

9. A gas return pipe (32) for a filling element (1) in accordance with claim 1, whereby the gas return pipe (32) comprises a liquid-deflecting shield (5) that is accommodated in a groove (36) of the gas return pipe (32), characterized in that the liquid-deflecting shield (5) comprises a metal-detectable plastic.

10. The gas return pipe (32) in accordance with claim 9, wherein the liquid-deflecting shield (5) is composed entirely of the metal-detectable plastic.

11. The gas return pipe (32) in accordance with claim 9, characterized in that the liquid-deflecting shield (5) comprises a body (50) that is substantially of conical form, preferably a conical frustum shape, and comprises a conical surface (54) to deflect the filling liquid, and which comprises a hole (52) to accommodate the gas return pipe (32) in the center of the body (50).

12. The gas return pipe (32) in accordance with claim 11, characterized in that the conical outer surface (54) is concave, preferably with a radius (R) that is larger than the maximum diameter (D) of the body (50) of the liquid-deflecting shield (5).

13. The gas return pipe (32) in accordance with claim 9, characterized in that the metal-detectable plastic is a thermoplastic, preferably a thermoplastic on the basis of ultra high molecular weight polyethylenes (UHMWPE), on the basis of POM, and/or on the basis of PA6.

14. A liquid-deflecting shield (5) for a filling element (1) or for a gas return pipe (32) in accordance with claim 1, whereby the liquid-deflecting shield (5) comprises a body (50) that is substantially of conical form, preferably a conical frustum shape, and comprises a conical outer surface (54) to deflect the filling liquid, and which in addition comprises a hole (52) to receive the gas return pipe (32) in the center of the body (50), characterized in that the liquid-deflecting shield (5) comprises a metal-detectable plastic.

15. The liquid-deflecting shield (5) in accordance with claim 14, characterized in that the conical outer surface (54) is concave, preferably with a radius (R) that is larger than the maximum diameter (D) of the body (50), and wherein the diameter (b) of the hole (52) is designed in such a manner with respect to the minimum diameter (d) of the body (50) that the resulting conical frustum surface (56) exhibits a thickness that permits a substantially smooth transition between the circumferential surface of the gas return pipe (32) and the conical outer surface (54) in the vicinity of the groove (36) when receiving the liquid-deflecting shield (5) in a groove (36) of the gas return pipe (32).
